(19) United States
(12) Patent Application Publication
(10) Pub. No.: US 2010/0111745 A1
(43) Pub. Date: May 6, 2010

(54) METHOD OF PRODUCING COMPOSITE MATERIALS THROUGH METAL INJECTION MOLDING

(76) Inventor: David J. Urevich, Wentzville, MO (US)

Correspondence Address: Polster, Lieder, Woodruff & Lucchesi, L.C., 12412 Powerscourt Dr. Suite 200, St. Louis, MO, 63131-3615, US

(21) Appl. No.: 12/525,237

(22) PCT Filed: Jan. 31, 2008
(86) PCT No.: PCT/US08/52619

§ 371 Date: Jul. 30, 2009

Related U.S. Application Data
(60) Provisional application No. 60/898,736, filed on Jan. 31, 2007.

(51) Int. Cl. B22F 3/26; B22F 3/02; B22F 1/00; B22F 3/12; B32B 15/00

(52) U.S. Cl. 419/27; 419/66; 75/228; 419/38

(57) ABSTRACT

A method for impregnating a metal injected material to produce a composite article (10). The method includes the steps of forming a green part (12) from a feedstock (14), removing a binder (16) from the green part (12) to form a brown part (18), and impregnating the brown part (18) with select particles (20) to form a finished composite article (10).

### CROSS-REFERENCE TO RELATED APPLICATIONS

This application claims priority to U.S. Provisional Application No. 60/898,736 filed Jan. 31, 2007 entitled METHOD OF PRODUCING COMPOSITE MATRIALS THROUGH METAL INJECTION MOLDING and which is incorporated herein by reference.

### BACKGROUND ART

The invention relates to metal injection molding, and more specifically, to a method of impregnating particles into a metal injection molded item, following the debinding process and prior to the sintering process in order to alter the characteristics of the item.

Metal injection molding is a process that has been developed and improved upon for many years. As with all products produced through a given process, there is a constant desire to improve the characteristics of the finished product by improving or altering the chosen process. Metal injection molding is no exception.

It is not uncommon in the field of metal injection molding to perform post-sintering processes to a finished part to enhance that part's characteristics, such as strength, durability, and hardness. Such treatments may include, for example, heat treatment, HIP, cryogenic freezing, plating, mechanical processing, etc. Yet, all of these processes take place after the completion of the metal injection molding process to enhance the characteristics of parts. Accordingly, it will be apparent that there continues to be a need to achieve some of the same, additional or even better finished product characteristics, through in-situ improvements or alterations to the known metal injection molding process itself.

### BRIEF DESCRIPTION OF THE DRAWINGS

In the accompanying drawings which form part of the specification:

FIG. 1 is a diagram of an injection molding process, according to an embodiment of the present invention.

FIG. 2 is a depiction of a debinding process, according to an embodiment of the present invention.

FIG. 3 is a depiction of an impregnation process, according to an embodiment of the present invention.

FIG. 4 is a depiction of a sintering process, according to an embodiment of the present invention.

FIG. 5 is a 50× magnification photograph of a polished cross-section of a “finished” part processed in accordance with an embodiment of the present invention.

Corresponding reference numerals indicate corresponding parts throughout the several figures of the drawings.

### BEST MODES FOR CARRYING OUT THE INVENTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

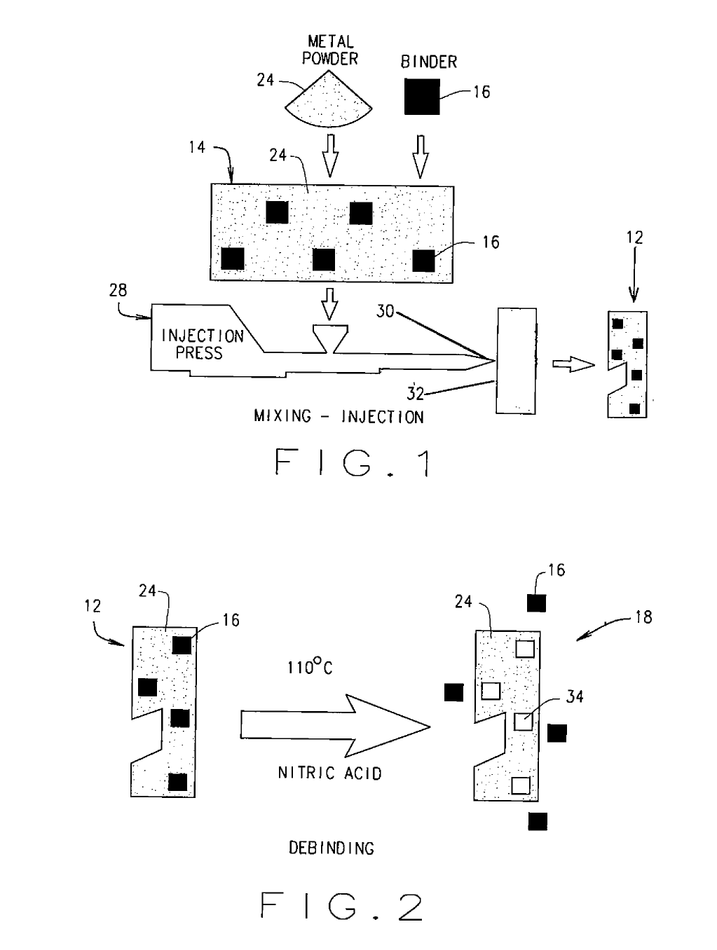

As shown in FIGS. 1-5, a first embodiment of the present invention comprises a method for impregnating a metal injected material to produce a composite article 10. Generally, the method includes the steps of forming a “green part” 12 from a feedstock 14, removing a binder 16 from the green part 12 to form a “brown part” 18, and impregnating the brown part 18 with select particles 20 to form a finished composite article 22.

Initially, a select composition 24 of one or more finely powdered metal(s), combines with a binder 16 to form the feedstock 14 (FIG. 1). In the embodiment of FIG. 1, the feedstock is a mixture of three to eight micron stainless steel powder and Acetel plastic binder, which can be obtained from BASF under the trade name “Catamold” and has the stock code of 316-L. However, the powdered metal can include any type of metal including elemental metals, one or more metal alloys, or any combination thereof. In addition, the binder 16 can comprise any type of plastic, wax, moisture, or other suitable material.

An injection molding machine 28, injects the feedstock 14 through a nozzle 30 into the mold 32, preferably at a temperature of approximately 190° C. The machine 28 applies a pressure of approximately 900 bar at approximately 128° C. for approximately three seconds to compress the injected feedstock 14 into a semi-rigid part, or what is known in the industry as a “green part” 12 or “green state”. When compressed, the binder 16 binds together the green part 12. Preferably, this entire injection molding stage has a cycle time of approximately 20 seconds. Those skilled in the art will recognize that the pressure, temperature, and time of compression can vary according to each application. For example, the pressure exerted on the feedstock 14 in the mold 32 during the compression phase varies with each application, but the pressure typically falls in the range of 500 psi to 1800 psi. After compression, the green part 12 ejects from the mold 32 and transfers to a debinding oven for removal of the binder 16.

Debinding typically consists of heating the green part 12 in the presence of a catalyst to dissolve the binder 16, leaving only enough material to just hold the finely powdered metals or metal alloys together. In the embodiment of FIG. 2, the debinding oven heats the green part 12 to approximately 110° C. and exposes the green part to Nitric acid having concentration of 98%. The green part 12 remains in this environment until achieving a weight loss of preferably at least 7%. After debinding, the article is often referred to as a “brown part” 18. The removal of the binder 16 yields a network of generally interconnected microscopic cavities 34 and interstitial voids or crevices in those areas of the brown part 18 where the binder 16 has been removed. These cavities 34 may range in size from sub-micron to 20+ microns. However, smaller and larger cavities may also be present.

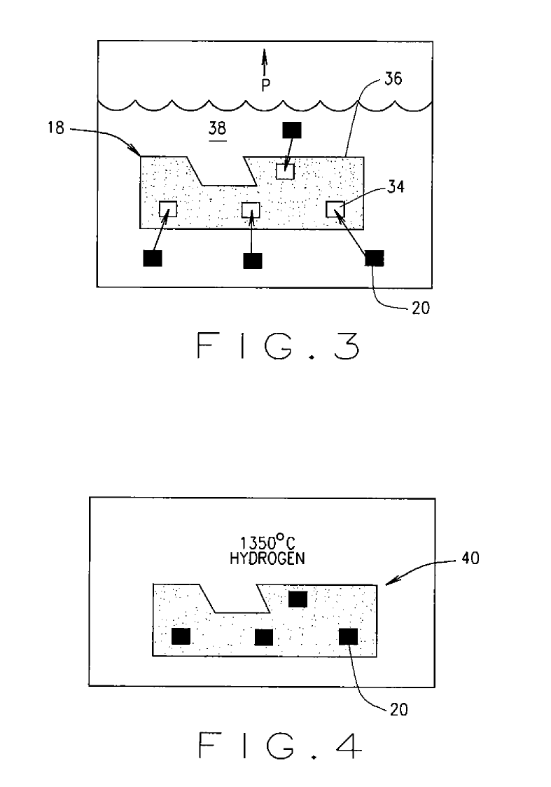

After debinding, the particles 20 are introduced to the surface 36 of the brown part 18 for impregnation. The particles 20 can comprise any type of material that provides desired characteristics or enhancements to the finished article 22, including metal, non-metal, plastic, ceramic, natural, or synthetic materials. Preferably, the particles 20 are suspended in a liquid solution 38, such as water or alcohol. In this way, the particles 20 migrate into the cavities 34 of the brown part 18 as a part of the liquid solution. The liquid solution may also include surfactants, such as fluorochemicals, silicone compounds, or soaps to lower the surface tension of the solution and allow the solution to infiltrate the network of cavities 34 more easily. The particles 20 should be generally sized smaller than the size of the cavities 34 to allow the particles 20 to infiltrate the network of cavities 34. In the embodiment of FIG. 3, the particles 20 of aluminum oxide (Al₂O₃) are preferably about 40 nanometers. However, the particles 20 can be sized to accommodate each individual application and its particular network of cavities 34. Many applications will utilize particles sized within a range of about 20 nanometers to about 80 nanometers.

The brown part 18 submerges or dips in the solution 38 for impregnation of the particles 20. Applicant believes that the impregnation of the particles 20 into the brown part 18 is enhanced naturally through capillary action. Further, the rate and extent of the particle incorporation may be adjusted by subjecting the brown part 18 to a pressure above atmospheric, or alternative by placing the brown part in a vacuum while submerged or coated with the liquid solution. In the embodiment of FIG. 3, a vacuum imparts a pressure P of approximately 3 psia below atmospheric pressure to the brown part 18 for a predetermined time period, such as overnight. After removal of the impregnated part 40 from the solution, the impregnated part 40 dries until the weight loss of the part 40 reaches equilibrium, thereby, indicating nearly all the moisture has been removed.

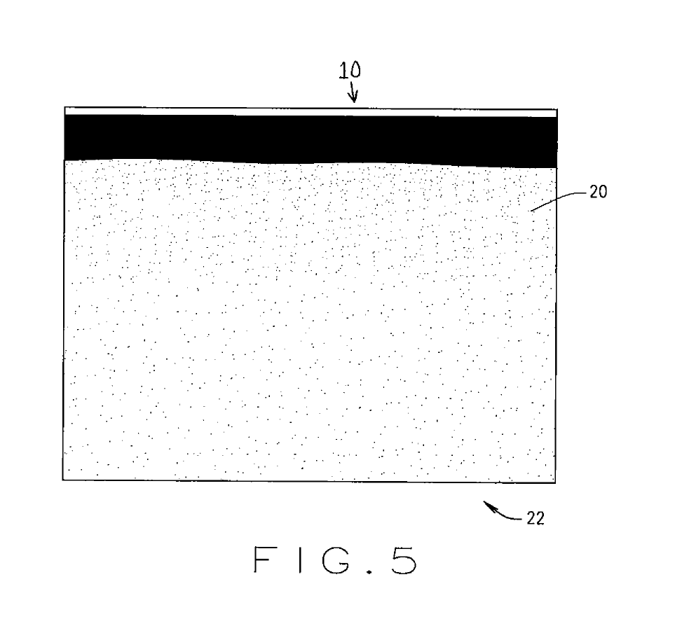

As shown in FIG. 5, the particles 20 impregnate into the surface of part 22 at a depth of about 0.01″. However, the depth of impregnation varies according to a number of factors, such as the size of the cavities, the size of the particles, the pressure used during impregnation, and the duration of the soak. The density of the particles 20 is about 30% by volume. Again, the density of the particles 20 varies according to a number of factors, such as the size of the cavities the size of the particles, the pressure used during impregnation, and the duration of the soak. Also, the particles can impregnate the entire part 22.

Following the impregnation of the particles 20, the impregnated part 40 is sintered, preferably using liquid phase sintering, in an oven at temperatures great enough to fuse but not melt the impregnated part 40. The sintering process traps the particles 20 in the part and completes the metal injection molding process to form a finished article 22. During sintering, the particles 20 do not necessarily or fully chemically bond to the brown part 18. Depending on the materials, the particles can either mechanically bond or chemically bond to the brown part. In the embodiment of FIG. 4 the impregnated part 40 is preferably sintered in a hydrogen reduction atmosphere at approximately 1350° C. for one hour. However, sintering may subject the impregnated part to temperatures of up to 2500° F. or more, in an environment in which the impregnated part is exposed to one or more gases to further improve the sintering process. Other processes may be used in place of sintering. In another alternate embodiment, an annealing technique could alternately be used in place of the sintering process.

If desired, the finished article 22 may also be subjected to post-sintering processes, such as heat treatment, HIP, cold forming, nitriding, carburizing, or other thermo-mechanical or mechanical processing.

Applicant believes that parts processed through this novel method will provide unique and otherwise desirable characteristics to completed articles, such as improved heat and chemical resistance, improved strength, corrosion and cracking resistance, anti-microbial, and anti-fungal properties that are vital in industries such as the medical and pharmaceutical fields. In addition, the novel method will produce cermet materials that can re-passivate their surface.

Applicant has discovered that using the novel method disclosed herein, the impregnation of submicron particles and/or nanometer sized particles of metal oxides or carbides into a brown part having a feedstock comprised of metal, metal alloys or non-metals, will result in a finished article having a composite composition not achievable using other methods. For example, the novel method permits a composite material with both metal and non-metal materials.

Changes can be made in the above constructions without departing from the scope of the invention, it is intended that all matter contained in the above description or shown in the accompanying drawings shall be interpreted as illustrative and not in a limiting sense. Other methods exist to impregnate the particles 20 into the brown part 18. In alternate embodiments, for example, the particles may be applied as a powder directly to the surface of the brown part. Alternatively, as another example, the particles may be suspended in a semi-gaseous state and applied to the brown article in an environmental chamber.

1. An improved metal injection molding method, the method comprising:
placing feedstock in a mold, the feedstock comprising a mixture of at least one metal and a binder;
compressing the feedstock in the mold to form a green part;
removing the green part from the mold;
removing at least some of the binder from the green part to form a brown part;
impregnating particles into the brown part, such that at least some of the particles impregnated into the brown part replace at least in part some of the removed binder; and
treating the brown part to trap the particles within the body of the brown part, thereby forming a finished part having a matrix with both residual feedstock materials and impregnated particles.

2. The method of claim 1 wherein the material for the feedstock comprises a metal powder.

3. The method of claim 1 wherein the material for the feedstock comprises a metal alloy powder.

4. The method of claim 1 wherein the binder comprises a plastic. wax.

5. The method of claim 1 wherein the binder comprises a

6. The method of claim 1 wherein the binder is removed, at least in part, through the application of heat to the green part.

7. The method of claim 1 wherein the binder is removed, at least in part, through the application of a chemical or catalyst to the green part, wherein the chemical or catalyst is capable of dissolving the binder.

8. The method of claim 1 wherein at least some of the particles are nanometer sized.

9. The method of claim 1 wherein at least some of the particles are sized in the range of about 20 nanometers to about 80 nanometers.

10. The method of claim 1 wherein the particles are introduced into the brown part by applying a solution to the surface of the brown part, wherein the solution comprises the particles.

11. The method of claim 10, wherein the brown part is dried, at least in part, between multiple applications of the solution.

12. The method of claim 10, wherein the application comprises immersion.

13. The method of claim 12, wherein the part is subjected to a reduced pressure during the immersion.

14. The method of claim 1, wherein the step of treating the brown part comprises sintering.

15. The method of claim 1, wherein the step of sintering the brown part increases the density of the part and reduces the size of the part.

16. The method of claim 1, wherein the feedstock is injected into the mold.

17. The method of claim 16, wherein the step of injection comprises heating the feedstock.

18. A metal injection molded part, the part having a body formed from feedstock comprising powdered metal and binder, wherein during the metal injection molding process at least some of the binder has been replaced with particles, the process trapping the particles in the body of the part.

19. The metal injection molded part of claim 18, wherein at least some of the particles are nanometer sized.

20. The metal injection molded part of claim 18, wherein the metal injection molding process comprises the step of sintering, and the particles are entrapped during the sintering step.

21. The method of claim 18 wherein at least some of the particles are sized in the range of about 20 nanometers to about 80 nanometers.

22. A metal injection molded part, comprising:
a body formed from feedstock comprising powdered metal and binder;
a network of generally interconnected cavities defined within the body after at least a portion of the binder is removed; and
particles impregnated within at least a portion of the network of generally interconnected cavities.

23. A metal injection molding method, the method comprising:
placing feedstock in a mold, the feedstock comprising a mixture of at least one metal and a binder;
compressing the feedstock in the mold to form a green part;
removing the green part from the mold;
removing at least some of the binder from the green part to form a brown part having a network of cavities;
impregnating particles into the network of cavities; and
sintering the brown part, thereby forming a composite material comprising feedstock and impregnated particles.
